(19) United States
(12) Patent Application Publication
(10) Pub. No.: US 2009/0265061 A1
(43) Pub. Date: Oct. 22, 2009

(54) DRIVING ASSISTANCE DEVICE, DRIVING ASSISTANCE METHOD, AND PROGRAM

(75) Inventors: Kazuya Watanabe, Aichi-ken (JP); Masaya Otokawa, Gifu-ken (JP); Yu Tanaka, Aichi-ken (JP); Tsuyoshi Kuboyama, Aichi-ken (JP); Kosuke Sato, Aichi-ken (JP); Jun Kadowaki, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi, Aichi-ken (JP)

(21) Appl. No.: 12/441,281

(22) PCT Filed: Nov. 9, 2007
(86) PCT No.: PCT/JP2007/071819

§ 371 Date: Mar. 13, 2009

(30) Foreign Application Priority Data
Nov. 10, 2006 (JP) 2006-305729

(51) Int. Cl. G08G 1/16; G06F 7/00

(52) U.S. Cl. 701/36

(57) ABSTRACT

Driving assistance is provided to a vehicle driver in a manner that is easy to understand and at a low cost. At a driving assistance device (100), an image processing unit (103) sets a cut-out region within image data photographed by a camera (121) and extracts cut-out image data. A control unit (107) generates information indicating risk to the rear of the vehicle based on the position and speed of other vehicle measured by a distance measuring unit. The image processing unit (103) then outputs information indicating the cut-out image data and the risk to a monitor (123). The image processing unit (103) then moves the cut-out region to a direction in which a vehicle route has changed when a receiving unit (105) receives notification to the effect that the route of the vehicle has changed.

### TECHNICAL FIELD

The present invention relates to a driving assistance device, a driving assistance method, and a program for assisting in the driving of a vehicle.

### BACKGROUND ART

It is extremely important for a driver to accurately understand information relating to other vehicles traveling in the vicinity of the vehicle and obstacles etc. while traveling. Various devices have therefore been developed in order to assist the driver driving. For example, a device is disclosed in Patent Literature 1 that informs the driver as to the extent of the proximity of vehicles traveling to the rear of the vehicle. This device displays the extent of the proximity of the vehicle to the rear (risk potential) using an indicator image. The driver is then able to comprehend the risk to the rear of the vehicle by looking at the indicator image.

Devices are also provided to provide assistance to the driver when a vehicle is changing lanes. For example, in Patent Literature 2, a device is disclosed that provides assistance so as to make it easy to change lanes even when a difference in speed with a vehicle traveling in a lane next to the vehicle is small. It is then possible for the driver to drive the vehicle in accordance with guidance displayed for accelerating and changing lanes because the device calculates appropriate inter-vehicular distance and speeds etc. suitable for when changing lane.

In Patent Literature 3, a device is disclosed that provides a display that assists in changing lanes when the operation of an indicator by the driver is detected. This device changes the brightness or color of segments displaying traveling environment information for to the left, right, and to the rear of the vehicle when the operation of the indicators is detected. The driver can then comprehend the level of danger by watching the changes in the display.

In Patent Literature 4, a device is disclosed that provides assistance in changing lanes by providing an image of what is to the rear of the vehicle to the driver at an appropriate time. This device provides an image of what is to the rear of the vehicle with two screens based on the relative relationship with vehicles to the front even without a specific lane change instruction from the driver. The driver can then change lanes by just referring to this image as necessary.

In Patent Literature 5, a device is disclosed that provides assistance in changing lanes by displaying guidelines overlaid with an image of what is to the rear of the vehicle. This device displays whether a distance is a distance that is unsuitable for turning right or left or for changing lanes, a distance where caution is required, or a distance that does not present any problems using guideline bars. A driver can then drive in an appropriate manner while looking at the guideline bars.

A device is disclosed in Patent Literature 6 that is capable of photographing a broad range to the rear of a vehicle. This device changes an angle of the camera using an actuator in response to operation of a steering wheel or operation of an indicator. The driver can then drive while confirming images for directions that should be taken particular note of.
[Patent Literature 1] Unexamined Japanese Patent Application KOKAI Publication No. 2005-145292
[Patent Literature 2] Unexamined Japanese Patent Application KOKAI Publication No. 2006-324727
[Patent Literature 3] Unexamined Japanese Patent Application KOKAI Publication No. 2002-074596
[Patent Literature 4] Unexamined Japanese Patent Application KOKAI Publication No. 2005-141484
[Patent Literature 5] Unexamined Japanese Patent Application KOKAI Publication No. 2006-051850
[Patent Literature 6] Unexamined Japanese Patent Application KOKAI Publication No. 2002-204446

### DISCLOSURE OF INVENTION

### Problems To Be Solved by the Invention

In the technology of the related art described above, it is not easy for the driver to immediately discern speeds and routes by looking at indicators on a screen, operation guidance, segments, or guidelines etc. Costs for the systems are also high as the result of actuators or a plurality of cameras being required.

In order to resolve the above situation, it is therefore an object of the present invention to provide a driving assistance device, a driving assistance method, and a program that helps a driver of a vehicle drive by providing displays in a manner that is easy to understand. A further object of the present invention is to provide a driving assistance device, a driving assistance method, and a program that can be constructed at a low cost.

### Means for Resolving the Problems

In order to achieve the above object, a driving assistance device of a first aspect of the present invention comprises:
a photographing unit that photographs an image to the rear of a vehicle;
a driving information acquiring unit that acquires driving information indicating vehicle driving conditions;
a route determining unit that determines the presence or absence of a change of a vehicle route and a direction of the change of the vehicle route based on the driving information acquired by the driving information acquiring unit;
an extracting unit that extracts a prescribed region from an image taken by the photographing unit based on the direction of the change of the vehicle route determined by the route determining unit when the vehicle route is determined to have changed by the route determining unit; and
a display unit that displays the image extracted by the extracting unit.

An assistance information generating unit that generates assistance information for assisting a driver based on the driving information acquired by the driving information acquiring unit and the image taken by the photographing unit can be also provided. The display unit can display the image extracted by the extracting unit and the assistance information generated by the assistance information generating unit.

The driving information acquiring unit can acquire information indicating whether the vehicle is within a prescribed distance range from road markings and information indicating a direction the vehicle approaches the road markings in as driving information, and the route determining unit determines whether the vehicle is changing route by determining whether or not the vehicle is within a prescribed distance range from the road markings, and can determine the direction of change of the vehicle route based on the direction the vehicle approaches the road markings in.

A storage unit that stores: vehicle type information indicating a type of a vehicle; and notification information for giving notification to a driver; in a correlated manner, and
a vehicle type determining unit that determines the type of other vehicle to the rear of the vehicle based on the image taken by the photographing unit, can be also provided.

The assistance information generating unit can then read out the notification information corresponding to the type of the other vehicle determined by the vehicle type determining unit and generate the assistance information including the notification information.

The assistance information generating unit can also generate guidelines that provide a guide of distance from the vehicle and information indicating a position of arrangement of the guidelines on the image extracted by the extracting unit as the assistance information.

A measuring unit that measures an inter-vehicular distance or a relative speed between the vehicle and the other vehicle can also be provided. The assistance information generating unit can generate information indicating the number, shape, size, color, and a position of arrangement of the guidelines based on the inter-vehicular distance or the relative speed measured by the measuring unit as the assistance information.

It is also possible for the driving information acquiring unit to acquire direction indication information that indicates which direction is being indicated by a direction indicator of the vehicle as the driving information, and for the route determining unit to determine the direction of the change of the vehicle route based on the direction indication information.

The driving information can include at least one of information indicating vehicle speed, information indicating acceleration, information indicating engine speed, information indicating that brakes are being applied, road guidance information, position information, traffic information, weather information, and road information.

A driving assistance method of a second aspect of the present invention comprises:
a photographing step of photographing an image to the rear of a vehicle;
a driving information acquiring step of acquiring driving information indicating vehicle driving conditions;
a route determining step of determining the presence or absence of a change of a vehicle route and determining a direction of the change of the vehicle route based on the driving information acquired in the driving information acquiring step;
an extracting step of extracting a prescribed region from the image taken in the photographing step based on the direction of the change of the vehicle route determined in the route determining step when it is determined that the vehicle route has changed in the route determining step; and
a displaying step of displaying the image extracted in the extracting step.

Further, in a program of a third aspect of the present invention,
the program enables a computer to function as:
a photographing unit that photographs an image to the rear of a vehicle;
a driving information acquiring unit that acquires driving information indicating vehicle driving conditions;
a route determining unit that determines the presence or absence of a change in a vehicle route and a direction of the change of the vehicle route based on the driving information acquired by the driving information acquiring unit;
an extracting unit that extracts a prescribed region from an image taken by the photographing unit based on the direction of the change of the vehicle route determined by the route determining unit when the vehicle route is determined to have changed by the route determining unit; and
a display unit that displays the image extracted by the extracting unit.

### EFFECTS OF THE INVENTION

According to the present invention, it is possible to provide a driving assistance device, a driving assistance method, and a program suited to providing driving assistance in a manner that is easy for a driver to understand and at low-cost.

### BRIEF DESCRIPTION OF DRAWINGS

FIG. 1 is a diagram illustrating a configuration for a driving assistance device of a first embodiment of the invention of the current application;

FIG. 2 is a diagram showing an example of image data taken by a camera of the first embodiment;

FIG. 3 is a flowchart explaining driving assistance processing executed by the driving assistance device of the first embodiment;

FIG. 4A is a diagram showing an example of photographed image data taken by a camera and a cut-out region of the first embodiment; FIG. 4B is a diagram showing an example of cut-out image data of the first embodiment;

FIG. 5A is a diagram showing an example of photographed image data taken by the camera and a cut-out region of the first embodiment; FIG. 5B is a diagram showing an example of cut-out image data of the first embodiment;

FIG. 6A is a diagram showing an example of image data composed from cut-out image data and information indicating a degree of risk of the first embodiment; FIG. 6B is a diagram showing an example of driving assistance data indicating the degree of risk of the first embodiment; FIG. 6C is a further diagram showing an example of driving assistance data indicating the degree of risk of the first embodiment; FIG. 6D is a diagram showing an example of information the user is notified of the first embodiment;

FIG. 7 is a diagram showing an example of the image data composed from cut-out image data and information indicating a degree of risk of a second embodiment of the invention of this application;

FIG. 8 is a diagram illustrating an example configuration for a screen projected at a monitor of a third embodiment of the invention of the current application; and

FIG. 9 is a flowchart explaining driving assistance processing of a fourth embodiment of the invention of the current application.

### EXPLANATION OF REFERENCE NUMERALS

driving assistance device 100
photographing unit 101
measuring unit 102
image processing unit 103 (extracting unit, output unit)
audio processing unit 104
receiving unit 105 (notification unit)
storage unit 106
control unit 107 (generating unit)
system bus 108
camera 121
distance measuring unit 122
monitor 123
speaker 124
operation panel 125
information indicating driving conditions 151
photographed image data 201
cut-out image data 202
cut-out region 401 (prescribed region)
risk guidance lines 601 (information indicating risk)
information notified to user 602
risk guidance regions 701 (information indicating risk)
screen 800
information displaying region 801
field of view display region 802
message display region 803
vehicle 804
field of view range 805

### BEST MODE FOR CARRYING OUT THE INVENTION

### First Embodiment

Next, an explanation is given of the embodiments of the present invention. In the following explanation, an explanation is given assuming that a driver changes lanes while confirming to the rear of the vehicle while driving. However, this example is by no means limiting, and does not restrict the range of the present invention. “To the rear” of the vehicle is not restricted to a direction right behind the vehicle but can also include directions that are rearwards at an angle off to the left and right of the vehicle that can be confirmed by the driver using side mirrors etc.

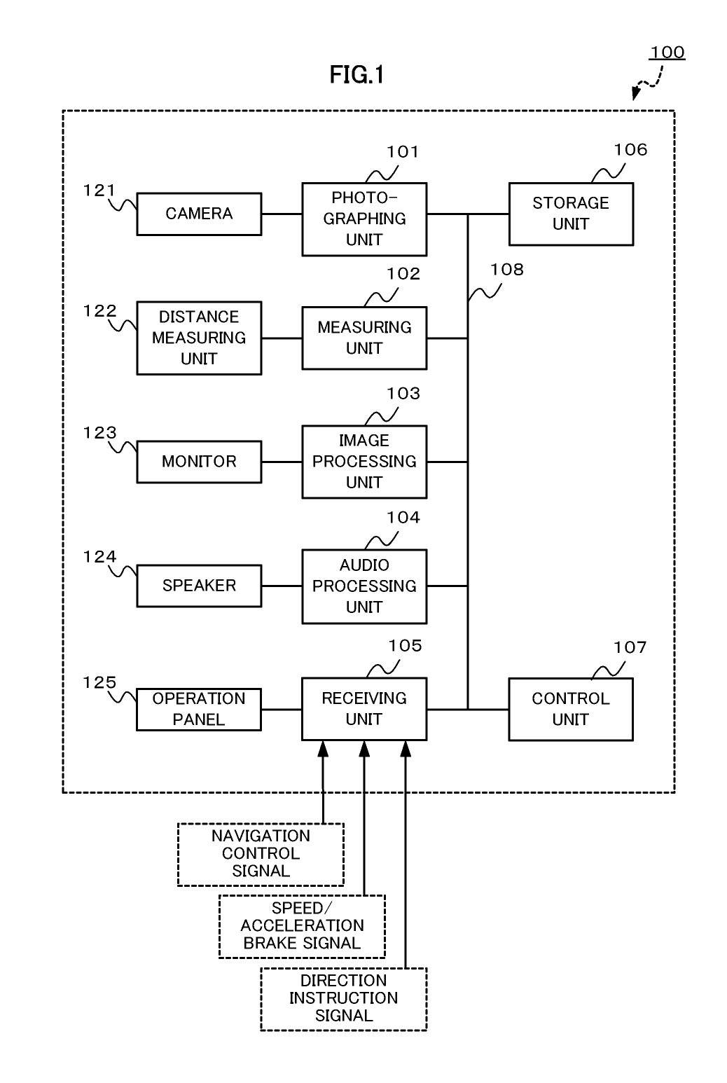

FIG. 1 is a diagram showing an example configuration for a driving assistance device 100 of this embodiment. As shown in this drawing, the driving assistance device 100 includes a photographing unit 101, a measuring unit 102, an image processing unit 103, an audio processing unit 104, a receiving unit 105, a storage unit 106, a control unit 107, and a system bus 108.

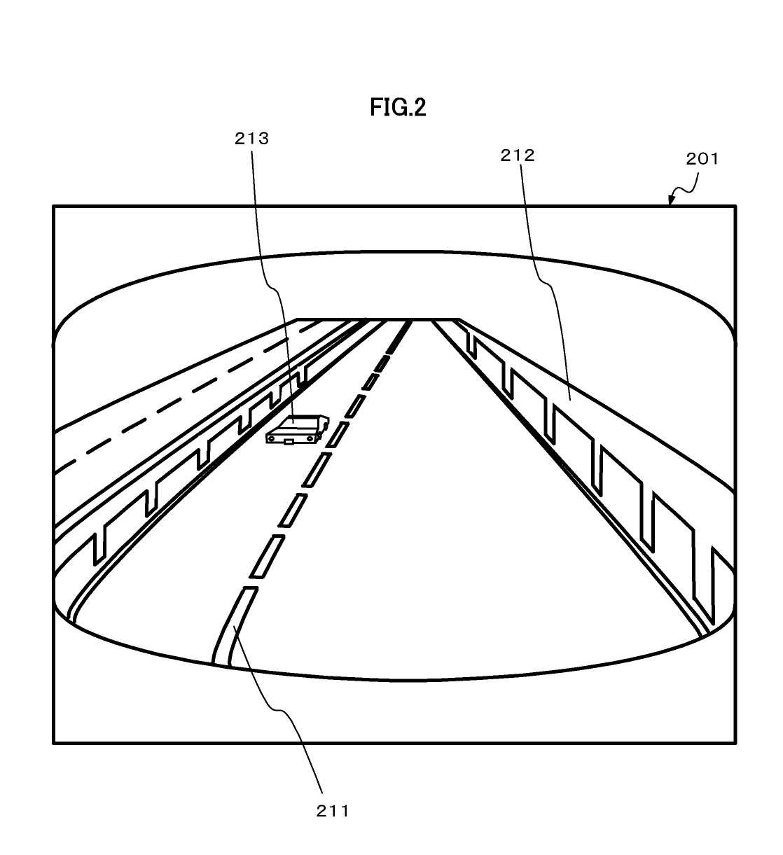

FIG. 2 is a diagram showing an example of image data (referred to as “photographed image data 201” hereafter) acquired by the photographing unit 101 that is a target for image processing by the image processing unit 103 described in the following.

The photographing unit 101 acquires the photographed image data 201 from a camera 121 that photographs to the rear of the vehicle and inputs the photographed image data 201 to the image processing unit 103. This photographed image data 201 is typically real-time moving image data. In this embodiment, the range of an image photographed by the camera 121 corresponds to a range reflected by a rear mirror and side mirrors of the vehicle. The camera 121 is a fisheye camera fixed at the rear of the vehicle. For example, the camera 121 is installed in the vicinity of a number plate or in the vicinity of the rear windscreen to the rear of the vehicle. A fisheye camera is suited to acquiring images of a broader range but it is also possible to adopt other types of cameras. The direction of photographing of the camera 121 is fixed in a prescribed direction but can also be changed depending on the situation. The photographing magnification is also fixed to a prescribed magnification but can also be changed depending on the situation. The photographed image data 201 taken by the camera 121 is displayed on a monitor 123 after being subjected to prescribed image processing by the image processing unit 103.

The measuring unit 102 acquires distance data from a distance measuring unit 122 that measures positions of other vehicles to the rear of the vehicle and measures relative speeds of the vehicle and other vehicles. For example, the distance measuring unit 122 is a radar that measures a distance to an object by emitting electromagnetic waves or ultrasonic waves of prescribed wavelengths and measuring waves reflected as a result. The measuring unit 102 inputs measured distance data and/or relative speed to the control unit 107. Objects measured by the measuring unit 102 are not limited to other vehicles traveling to the rear but can also be fixed objects such as buildings, obstacles, or passersby etc. The measuring unit 102 can also acquire motion vectors for the image data from difference information for a plurality of items of photographed image data 201 acquired by the photographing unit 101 for use in detecting the relative speeds of other vehicles with respect to the vehicle.

After the photographed image data 201 acquired by the photographing unit 101 is processed by an image computing processor (not shown) the control unit 107 or the image processing unit 103 is provided with, the image processing unit 103 records the photographed image data 201 in frame memory (not shown) the image processing unit 103 is provided with. The image information recorded in the frame memory is converted to a video signal at a prescribed synchronous timing and is outputted to the monitor 123 connected to the image processing unit 103. This means that various image displaying is possible. For example, the image processing unit 103 outputs an image for all of the photographed image data 201 or an image for image data cut-out for a prescribed region of the photographed image data 201 (hereinafter referred to as “cut-out image data 202”) to the monitor 123. The image processing unit 103 outputs an image composed of various data for providing driving assistance (hereinafter referred to as “driving assistance data”) of the photographed image data 201 or the cut-out image data 202 to the monitor 123. The driver can then look at images projected on the monitor 123 at any time. A configuration is also possible where a region of the photographed image data 201 acquired by the photographing unit 101 that is embedded in the video signal is set by a digital signal processor (DSP, not shown) the photographing unit 101 is provided with.

The driving assistance device 100 can be connected either by cable or wirelessly with an external device such as a car navigation system, a road traffic information communication system, or a television receiver (none of which are shown in the drawings). The image processing unit 103 can also subject moving images and static images inputted from such external devices to image processing for output. A configuration where the monitor 123 can be shared with other systems or devices such as these can also be adopted.

For example, FIG. 2 is an example of photographed image data 201 taken when the vehicle is traveling on the left side lane of a road with two lanes on each side, and shows the entire image taken by the camera 121. For example, in addition to road markings 211 depicted on the road surface and a side wall 212, other vehicle 213 traveling to the rear in the right side lane is also photographed in the photographed image data 201. Here, the road markings 211 indicate lines (center lines, side lines etc.) depicted on the road surface normally in white or yellow. Images taken by the camera 121 are outputted to the monitor 123 in real time. Image quality, the number of pixels, the number of colors, and the number of frames etc. for the monitor 123 are not limited by the present invention. The photographed image data 201 depicted in this drawing is given merely as an example.

Under the control of the control unit 107, the audio processing unit 104 converts audio data such as warning sounds and guidance speech stored in advance in the storage unit 106 using a D/A (Digital/Analog) converter (not shown) for playback by a prescribed playback program and outputs as audio from a speaker 124. The audio processing unit 104 can also output audio inputted from an external device such as a car navigation system, a road traffic information communication system, or a television receiver. A configuration where the speaker 124 can be shared with other systems or devices such as these can also be adopted.

The driving assistance device 100 can also be provided with a microphone for picking up sound emitted to the rear of the vehicle. Audio data for sound picked up by the microphone can be then outputted from the speaker 124. The driving assistance device 100 is capable of transmitting not only just images but also audio to the driver so as to bring about a more user-friendly interface.

The receiving unit 105 receives input of instructions by the user (driver or passenger etc.) using an operation panel 125 and inputs a control signal corresponding to the inputted instructions to the control unit 107. For example, the operation panel 125 includes an input interface for providing various instructions using a main power supply button of the driving assistance device 100 and buttons for adjusting picture quality and volume to the driving assistance device 100.

The receiving unit 105 receives input of information 151 indicating driving conditions of the vehicle and inputs a corresponding control signal to the control unit 107. For example, the information 151 indicating the driving conditions of the vehicle can be (a) a control signal for road guidance (navigation) information, position information, traffic information, weather information, or road information etc. inputted from a car navigation system or road traffic information communication system etc., (b) speed data, acceleration data, or a brake signal for the vehicle inputted from a speedometer, accelerometer, or breaking device the vehicle is provided with, or (c) a direction indication signal inputted from a direction indicator (blinker). The receiving unit 105 can also be configured to receive data including all or some of the examples cited in (a) to (c). For example, the configuration is also possible where inputs are received from a gradient sensor that measures the road gradient as well as the gradient for the vehicle to the left and right and front and rear.

The storage unit 106 stores position and speed data measured by the measuring unit 102, driving assistance data described in the following obtained by the control unit 107, an operating system (OS) for performing overall control of the driving assistance device 100, and various control programs etc. For example, the storage unit 106 can include a hard disk device, a ROM (Read Only Memory), a RAM (Random Access Memory), and a flash memory etc.

The control unit 107 can include, for example, a CPU (Central Processing Unit) or an ECU (Electronic Control Unit), and carries out overall control of the driving assistance device 100 in accordance with the OS and control programs stored in the ROM. The control unit 107 sends control signals and data to each part or receives response signals and data from each part as required for control. The control unit 107 carries out processing (hereinafter referred to as “driving assistance processing”) for providing information that provides the driver with driving assistance based on the conditions to the rear of the vehicle, the details of which are described in the following.

The system bus 108 is a transmission path for transferring instructions and data among the photographing unit 101, the measuring unit 102, the image processing unit 103, the audio processing unit 104, the receiving unit 105, the storage unit 106, and the control unit 107.

In addition to each of these parts, the driving assistance device 100 can also include (or be connected to) a CD-ROM (Compact Disc Read Only Memory) drive, a DVD-ROM (Digital Versatile Disc Read Only Memory) drive, a GPS (Global Positioning System) transceiver, a communication functions such as a mobile telephone, or an ETC (Electronic Toll Collection) system. In this embodiment, just one camera 121 that photographs to the rear of the vehicle is provided. However it is also possible to photograph a number of directions such as directions directly to the rear or directions inclined to the rear using a number of cameras. An image of what is to the rear of the vehicle can then be acquired from the images taken by these cameras.

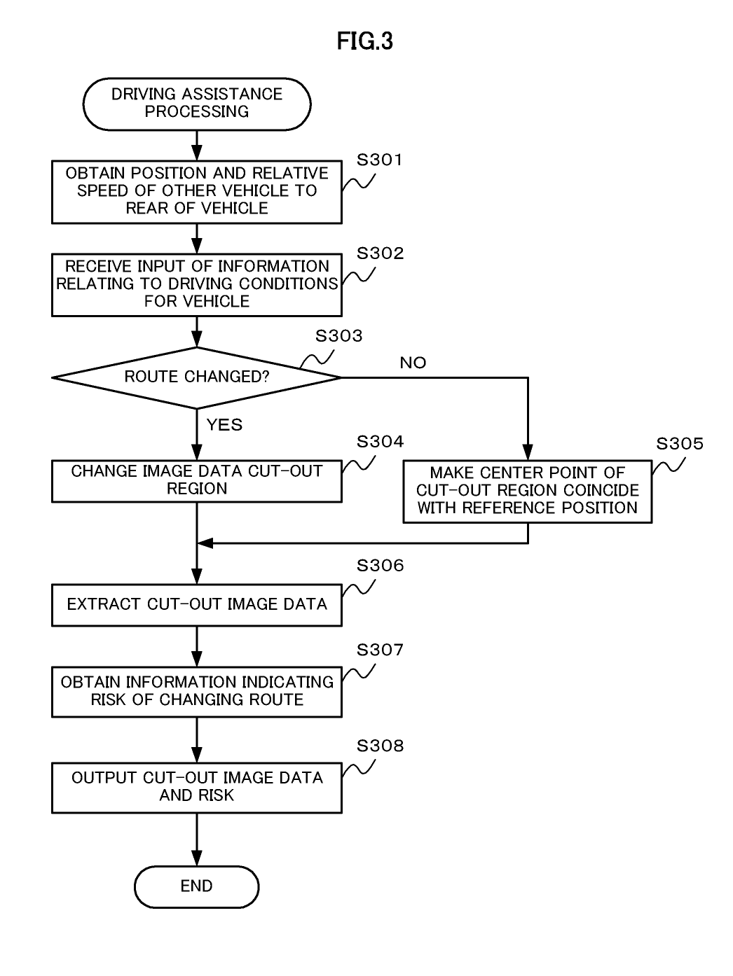

Next, an explanation is given of driving assistance processing carried out as a result of each of the parts described above of the driving assistance device 100 operating in cooperation. FIG. 3 is a flowchart illustrating the driving assistance processing. In the following description, it is taken that the camera 121 constantly takes images and the photographing unit 101 acquires the photographed image data 201, unless otherwise explicitly stated. The driving assistance processing is executed while driving, i.e. after the driver turns the engine of the vehicle on. This is described in the following.

First, under the control of the control unit 107, the measuring unit 102 measures the position of the other vehicle 213 near the vehicle, and measures the relative speed of the other vehicle 213 with respect to the vehicle (step S301). The measuring unit 102 then inputs information indicating the acquired position and the relative speed to the control unit 107. Alternatively, this information can be stored in a prescribed storage region of the storage unit 106 and can then be read out at an arbitrary timing by the control unit 107. In this embodiment, the “other vehicle 213” is a vehicle traveling to the rear of the vehicle and can refer to a vehicle traveling in the same lane directly to the rear of the vehicle or to a vehicle traveling in a neighboring lane (passing lane, uphill passing lane etc.). The vehicles can also be light vehicles such as motorcycles or bicycles traveling in the vicinity of the roadside to the rear of the vehicle.

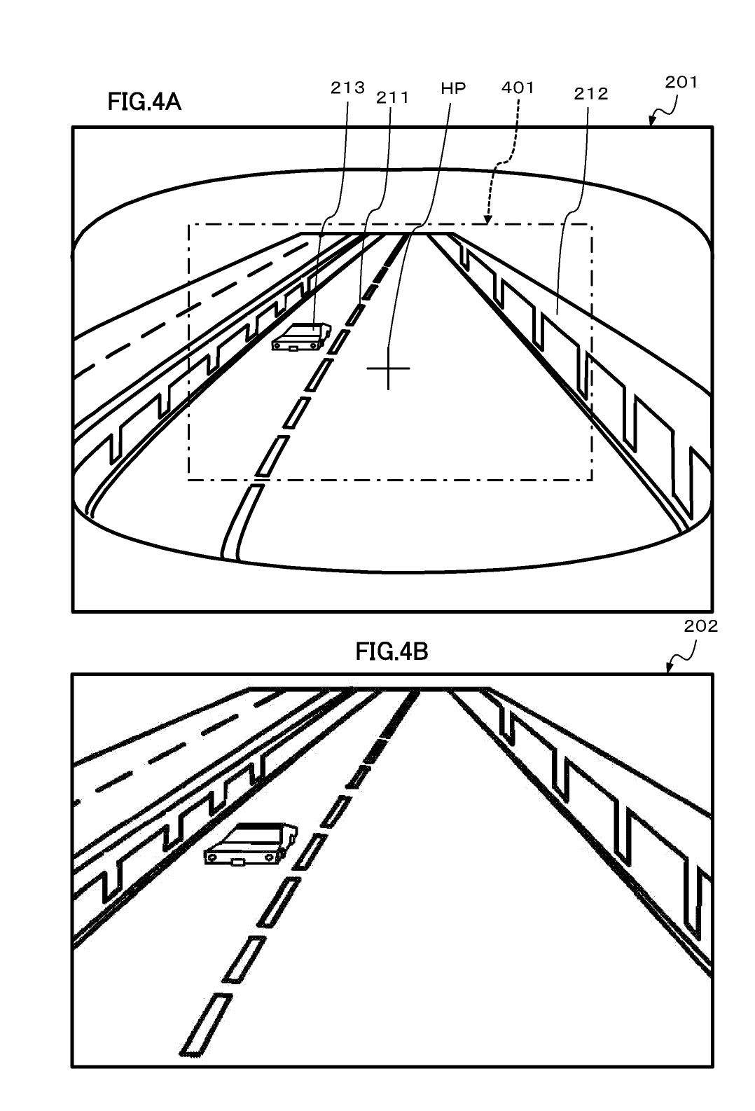

More specifically, as shown in FIG. 4A, the image processing unit 103 subjects the photographed image data 201 taken by the camera 121 to image analysis to discern the other vehicle 213. For example, it is possible for the image processing unit 103 to discern portions of images corresponding to the other vehicle 213 from within the photographed image data 201 using techniques employing pattern matching and spatial frequency etc. that are in broad use so as to identify the other vehicle 213. The measuring unit 102 then obtains the direction of the identified other vehicle 213. The measuring unit 102 obtains the distance to the identified other vehicle 213 and the relative speed based on the wavelength of electromagnetic radiation or ultrasonic waves emitted from a radar for distance measuring use the driving assistance device 100 is provided with, the time taken for reflective waves to arrive, and the vehicle speed etc. The measuring unit 102 can then obtain the position and relative speed of the other vehicle 213 traveling to the rear.

Of the information indicating the positions of the other vehicle 213, the information for the direction does not have to be particularly detailed information. For example, information for the direction can be simply “traveling in the same lane”, “traveling in the lane to the right (or the left)”, or “traveling two lanes to the right (or the left)”. The position, shape, or size etc. of portions of the image corresponding to the road markings 211 included in the photographed image data 201 can be pattern matched in order to determine which lane the other vehicle 213 or the vehicle is traveling in.

Next, the receiving unit 105 receives input of the information 151 indicating the driving conditions of the vehicle under the control of the control unit 107 (step S302).

For example, the information 151 indicating the driving conditions for the vehicle can be notification to the effect of a vehicle straddling the road markings 211 such as white lines on the road surface. This is to say that the image processing unit 103 identifies road markings 211 such as white lines depicted on the road surface using typically employed methods such as pattern matching. It is then determined whether the road markings 211 are in a position that is straddled by the vehicle. When this is determined to be the case, the receiving unit 105 is notified that the vehicle route is straddling the road markings 211. It is also possible to give notification to the effect of being within a prescribed distance from the road markings 211 even if the vehicle is not actually straddling the road markings 211.

In this manner, the image processing unit 103 also functions as a notification unit that identifies the road markings 211 on the road the vehicle is traveling on that gives notification to the effect of being within a prescribed distance range from the road markings 211 when the vehicle is within a prescribed distance range from the road markings 211.

The control unit 107 determines whether or not the vehicle route changes based on the information 151 indicating the driving conditions received by the receiving unit 105 (step S303). For example, when the receiving unit 105 receives notification to the effect that the route of the vehicle is straddling the road markings 211, the receiving unit 105 sends to the control unit 107 an input informing that it is in receipt of the notification. The control unit 107 then determines whether the route of the vehicle has changed.

When it is determined that the route of the vehicle has changed (step S303; Yes), the image processing unit 103 modifies a cut-out region 401 set to part of the photographed image data 201 (step S304). As shown in FIG. 4B, the image processing unit 103 extracts image data included in the cut-out region 401 from the photographed image data 201 as the cut-out image data 202 (step S306).

Namely, the image processing unit 103 decides upon a prescribed rectangular region as the cut-out region 401 and extracts image data included in the cut-out region 401 as the cut-out image data 202. The image processing unit 103 can arbitrarily change the position of the cut-out region 401.

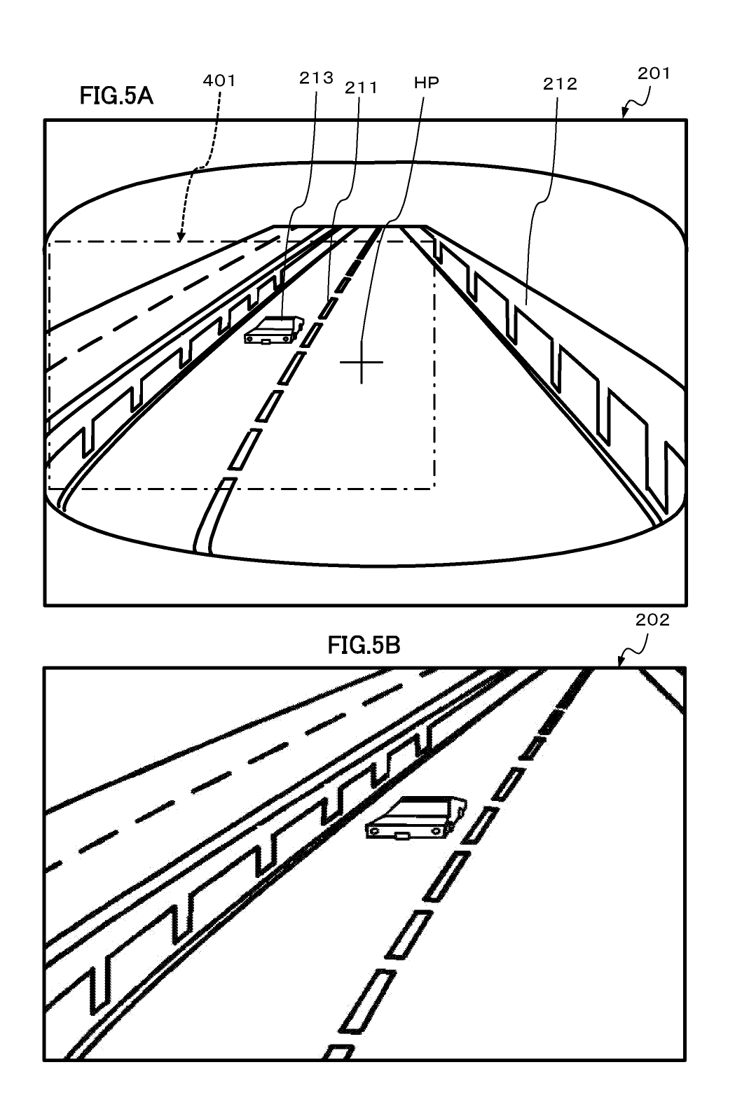

For example, when the image processing unit 103 determines that the vehicle is straddling the road markings 211, the direction of the straddling of the road markings 211 can be determined as the direction of change of the vehicle route. When a route the vehicle is traveling in turns to the right (or left), the vehicle straddles the right side (or the left side) road markings 211 (in other words, the photographed image data 201 gives an image where the vehicle straddles the right side (or the left side) road markings 211). It can therefore be determined that the direction of change in the route of the vehicle is the right side (or the left side). As shown in FIG. 5A, the image processing unit 103 then moves the cut-out region 401 of the photographed image data 201 photographed by the camera 121 in the direction of change of the vehicle route. The cut-out image data 202 corresponding to the moved cut-out region 401 at this time is as shown in FIG. 5B.

Numerous variations can be considered as ways of moving the cut-out region 401. In this embodiment, the image processing unit 103 gradually consecutively moves the cut-out region 401 in the direction of change of the vehicle route. Namely, the direction (a direction of the line of sight of the camera) of the image projected on the monitor 123 is gradually made in the direction of change of the vehicle route so that discontinuous breaks such as with time lapses do not occur midway through changing. The user therefore does not lose sight of the direction the image projected on the monitor 123 is in.

The image processing unit 103 moves the cut-out region 401 to a greater extent for a larger change in the vehicle route. Namely, the image processing unit 103 moves the cut-out region 401 to a greater extent for a larger extent of movement of the image corresponding to the road markings 211 contained in the photographed image data 201.

The image processing unit 103 also makes the speed of movement of the cut-out region 401 faster for a faster change in the vehicle route. Namely, the image processing unit 103 makes the amount of movement of the cut-out region 401 per unit time larger for a larger extent of movement per unit time of the image corresponding to the road markings 211 included in the photographed image data 201. The direction of the image on the monitor 123 (a direction of the line of sight of the camera) changes slowly when the vehicle route changes slowly and changes quickly when the vehicle route changes quickly. The driving assistance device 100 can provide useful information to the user depending on driving conditions.

The image processing unit 103 can move the position of the cut-out region 401 within the limit of not moving out from the photographed image data 201. Namely, in FIG. 5A, the left end of the rectangle denoting the cut-out region 401 is made to move so as not to go further to the left side than the left end of the photographed image data 201. The same applies for the right end, the upper end, and the lower end.

The image processing unit 103 can also take into consideration other elements in combination with the direction of change of the vehicle route such as change in the direction of movement, the shape, the enlargement ratio (reduction ratio), and the resolution of the cut-out region 401. For example, it is also possible to change the shape and size of the cut-out region 401 as the speed of the other vehicle 213 identified to the rear (or the relative speed of the other vehicle 213 with respect to the vehicle) increases so as to change the range of the cut-out image data 202. It is therefore possible to display the distance between the approaching other vehicle 213 and the vehicle in a flexible manner that is easy to understand.

The shape of the cut-out region 401 is not limited to being rectangular and can also be other shapes.

In this manner, the image processing unit 103 also functions as an extracting unit that extracts the cut-out image data 202 from the photographed image data 201.

On the other hand, in step S303, when it is determined that the vehicle route has not changed (step S303; No), the driving assistance device 100 moves the cut-out region 401 so that a center point of the cut-out region 401 coincides with a reference position HP (step S305).

The reference position HP is a state where there is no change in the vehicle route, in other words, a default position for immediately after the power supply of the driving assistance device 100 is switched on and is a home position set in advance by the image processing unit 103. For example, a center point of the photographed image data 201 photographed by the fisheye lens is taken to be the reference position HP as shown in FIGS. 4A and 5A. This reference position HP is not particularly important information for the user and is therefore not displayed on the monitor 123 as shown in FIGS. 4B and 5B. The image processing unit 103 gradually and continuously moves the cut-out region 401 while returning it to the home position so that the image does not exhibit any discontinuity such as with time lapses midway.

After changing the position of the cut-out region 401 (step 304), and returning the cut-out region 401 to the home position (step S305), the image processing unit 103 extracts the image data included in the set cut-out region 401 as the cut-out image data 202 (step S306).

Next, the control unit 107 obtains information (driving assistance data) indicating the degree of risk for when a vehicle is changing route (step S307).

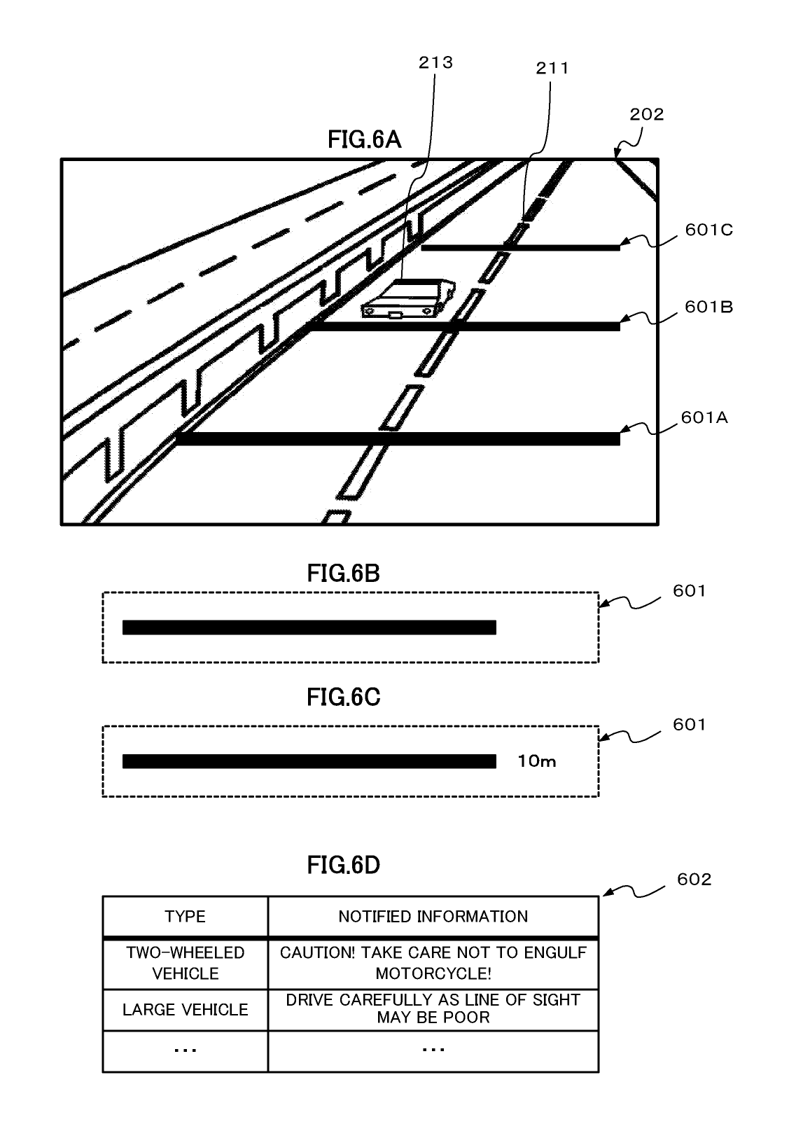

More specifically, the control unit 107 calculates the distance of a prescribed point of the cut-out image data 202 from the vehicle, and obtains a number of guidelines (guideline bars), shape, color, size, and positions for displaying the guidelines (guideline bars). Here, “guideline” (guideline bar) is a graphic that is a guideline or guidance for distance from the vehicle that is displayed to provide driving assistance to the driver. For example, guidelines (guideline bars) shown in FIG. 6A can be long slender lines (hereinafter referred to as “risk guidance lines” 601. The number, thickness, color, and positional arrangement of the risk guidance lines are then changed depending on the degree of risk. The risk guidance lines 601 are information (driving assistance data) indicating a degree of risk (safeness) for the user when the vehicle changes lane or changes route. For example, as shown in FIG. 6A, the control unit 107 decides upon the positions to draw the risk guidance lines 601 (601A, 601B, 601C in the drawings) so as to closely fit with the positional relationship of the cut-out image data 202. The control unit 107 makes points within the cut-out image data 202 and the actual distance correspond using a prescribed distance (for example, 10 meters etc.) from the rear end section of the vehicle and decides upon positions for displaying the risk guidance lines 601 on the monitor 123 as shown in FIG. 6B.

The control unit 107 also changes the positions to draw the risk guidance lines 601 according to the relative speed of the other vehicle 213 with respect to the vehicle. Namely, when the relative speed is fast, the time until the arrival of the approaching vehicle is short. The interval between the risk guidance lines 601 is therefore made broad and when the relative speed is slow, the interval between the risk guidance lines 601 is made narrow.

In this embodiment, the control unit 107 obtains the positions of a plurality of risk guidance lines 601 and makes the risk guidance lines 601 closest to the vehicle (601A in FIG. 6A) red and thick. As the vehicle is then moved away from, the color of the lines is changed to red/yellow/blue and the lines gradually become thinner. The control unit 107 performs control so as to determine the level of risk depending on the position and speed (relative speed) of the other vehicle 213 as measured by the measuring unit 102 and to display the risk guidance lines 601 in an emphasized manner depending on the results of the determination.

It is also possible to adopt embodiments where the number, color, shape, length, thickness, size, and the interval between the risk guidance lines 601 that are the driving assistance data are arbitrarily changed and such modified examples are also included in the scope of the present invention. Is also possible to have the risk guidance lines 601 flash on and off or change in color over time. A configuration can also be adopted where the image processing unit 103 outputs images including the risk guidance lines 601 and the audio processing unit 104 ensures that warning sounds or notification speech etc. is played back from the speaker 124.

The driving assistance data is not limited to the risk guidance lines 601 and can also include other information. For example, as shown in FIG. 6C, it is also possible to have the character information etc. indicating guidance for actual distance that is correlated to their respective risk guidance lines 601.

In an example application, when the other vehicle 213 approaches from the rear, it is possible for the control unit 107 to calculate an estimated speed for the other vehicle and an estimated time for the other vehicle to reach the vicinity of the vehicle, with this being adopted as driving assistance data together with the risk guidance lines 601.

In a further example application, when the other vehicle 213 approaches from the rear, the image processing unit 103 determines the vehicle type and body of the other vehicle using an image processing method such as pattern matching based on data that makes it possible to discern various vehicle types and body sizes that is stored in advance in the storage unit 106. The control unit 107 can then also use information for the vehicle type and body etc. discerned by the image processing unit 103 as one item for the driving assistance data. For example, the image processing unit 103 can classify the other vehicle approaching from the rear into classifications such as a light vehicle such as a motorcycle/a regular vehicle/or a large sized vehicle such as a truck. The control unit 107 can then adopt the results of this classification as one item for the driving assistance data. For example, as shown in FIG. 6D, a vehicle type classification and information 602 notifying the user when this type of the other vehicle 213 is approaching are stored in advance in the storage unit 106. The control unit 107 then creates driving assistance data based on this information. The method of classification is arbitrary and information 602 the user is notified of can be outputted as characters or images or can be outputted using audio etc. It is then possible to change the information that can be provided to the user to content that is appropriate depending on the circumstances depending on the discerned type of vehicle so as to give “be careful not to engulf” for a motorcycle, or “caution, line of sight may be poor” for a large vehicle etc. The content of the information provided can then be changed arbitrarily. The methods for discerning the vehicle type and body are not limited to the above.

The control unit 107 can therefore generate useful driving assistance data to provide assistance with regards to the distance to the rear of the vehicle in a manner that is easy for the user to get a comprehend. This means that the control unit 107 functions as a generating unit that generates information indicating the degree of risk when the vehicle is changing route based on information measured by the measuring unit 102.

The image processing unit 103 outputs the cut-out image data 202 together with the driving assistance data (data indicating the degree of risk) obtained by the control unit 107 in step S306 (step S307). This is to say that the image processing unit 103 functions as an output unit that outputs information indicating the degree of risk and the cut-out image data 202. For example, the image processing unit 103 outputs an image as shown in FIG. 6A to the monitor 123. The user can therefore drive while avoiding risks by referring to an image of what is to the rear of the vehicle and useful driving assistance data for driving safely. The driving assistance device 100 then ends the driving assistance processing after step S307.

According to this embodiment, the driving assistance device 100 is capable of providing useful information that helps the driver drive the vehicle. In this embodiment, an explanation is given of the case of applying the present invention to when a vehicle is changing lane but this is provided merely as an example and does not limit the content of the present invention. It is also possible to change the position of the cut-out image (step S304) and produce driving assistance data (step S307) even when lane changing does not take place while driving. For example, it is also possible to carry out this processing (steps S304, S307) when the vehicle is reversing, when the driver operates a direction indicator (blinker), or when other vehicle or pedestrian suddenly comes close to the rear of the vehicle.

### Second Embodiment

Next, a description is given of a further embodiment of the present invention. In this embodiment, the way of providing information (driving assistance data) indicating the degree of risk is different. Other aspects of the configuration are the same as for the embodiment described above, with common portions being given the same reference numerals. Portions that are the same as before will not be described.

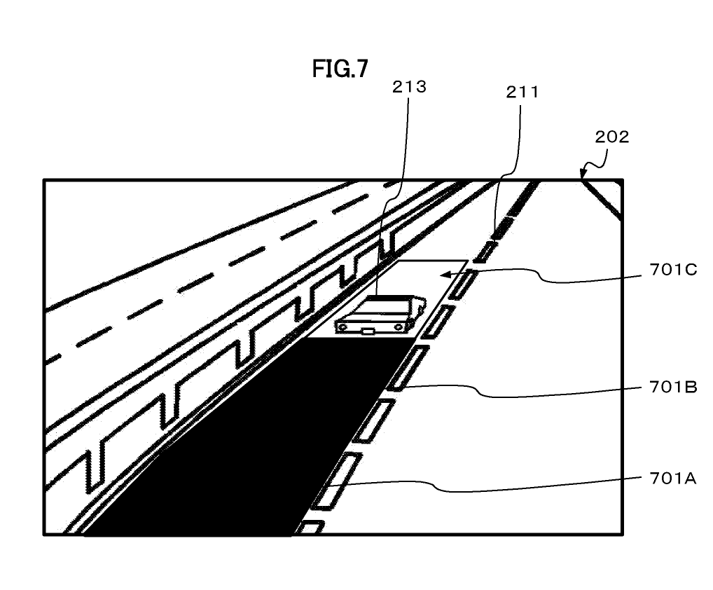

FIG. 7 is an example of cut-out image data 202 generated by the image processing unit 103 and driving assistance data in this embodiment. The driving assistance data includes risk guidance regions 701 (described as 701A, 701B, 701C in the drawing). The control unit 107 makes points within the cut-out image data 202 and the actual distance correspond using a prescribed distance (for example, 10 meters etc.) from the rear section of the vehicle, performs split-up into several regions using distance range, and takes the respective regions to be the risk guidance regions 701. For example, it is divided so that a region for an actual distance from the rearmost end of the vehicle up to LI is taken to be a risk guidance region 701A, and a region of a distance from L1 to L2 is taken to be a risk guidance region 701B. The control unit 107 performs control so as to determine the level of risk depending on the position and speed (relative speed) of the other vehicle 213 as measured by the measuring unit 102 and displays the risk guidance lines 701 in an emphasized manner depending on the results of the determination. The image processing unit 103 displays the different risk guidance regions 701 using different colors and synthesizes the regions with the cut-out image data 202 so as to generate image data to be projected on the monitor 123.

Further, the control unit 107 can change the positions of dividing up the risk guidance region 701 depending on the relative speed of the other vehicle 213 with respect to the vehicle. Namely, when the relative speed is fast, the intervals of the positions for dividing up the risk guidance region 701 are broadened, and when the relative speed is slow, the intervals of the positions for dividing up the risk guidance region 701 are made narrow.

The way of displaying each of the risk guidance regions 701 is not limited. For example, it is also possible to adopt embodiments where the number, color, shape, length, size, and the intervals between the risk guidance regions 701 are arbitrarily changed and such modified examples are also included in the scope of the present invention. It is also possible to have the risk guidance regions 701 flash on and off or change in color over time. The image processing unit 103 can also output images including the risk guidance regions 701 and the audio processing unit 104 can also ensure that warning sounds or notification speech etc. is played back from the speaker 124.

### Third Embodiment

Next, a description is given of a further embodiment of the present invention. In this embodiment, the content of information received by the receiving unit 105 as the information 151 indicating vehicle driving conditions is different to the embodiment described above. This is described in the following.

The receiving unit 105 receives a direction indication signal inputted by a direction indicator (blinker) fitted to the vehicle as information 151 indicating the vehicle driving conditions (step S302).

The control unit 107 determines whether or not there is a change in the vehicle route based on the direction indication signal received by the receiving unit 105 (step S303). For example, when the vehicle direction indicator indicates that the route is changing to the right (or to the left), the receiving unit 105 inputs an indication to the effect that the direction indication signal is received to the control unit 107. The control unit 107 then determines whether the vehicle route is changing to the right (or to the left).

It is also possible to adopt a configuration where the driving assistance processing described above is started when the receiving unit 105 receives the direction indication signal.

Other aspects of the configuration are the same as for the embodiments described above. Portions that are the same as before will not be described.

The receiving unit 105 can also receive a control signal such as for road guidance (navigation) information, position information, traffic information, weather information, and road information etc. inputted by a car navigation system or a road traffic information communication system etc. connected to the driving assistance device 100 as the information 151 indicating vehicle driving conditions. The control unit 107 can also determine whether or not there is a change in the vehicle route based on the control signal received by the receiving unit 105. It is also possible to adopt a configuration where the driving assistance processing is started when the receiving unit 105 receives these control signals.

For example, it is also possible for the control unit 107 to determine that there is a change in the vehicle route when the road guidance information from the car navigation system etc. is information to the effect that the vehicle is to turn right or left within a prescribed time. It is preferable for the image processing unit 103 to move the cut-out image data 202 to be in a direction indicating information to the effect that the vehicle is to turn to the right or left.

For example, the control unit 107 can determine that the vehicle route has changed when position information from the car navigation system etc. is information to the effect that the vehicle is at a position within a prescribed distance from a prescribed road installation or road point such as an entry or exit point (interchange) of an expressway, a tollgate, a ticket barrier, a merging junction, a branching junction (junction), a resting place (service area or park area), a bus stop, a traffic signal, or an intersection. In this event, there is the possibility that the vehicle route has changed. The control unit 107 therefore assumes that the vehicle route has changed and can carry out driving assistance processing. It is preferable for the image processing unit 103 to move the cut-out image data 202 in a direction from the vehicle close to a road installation or road point.

For example, it is also possible for the control unit 107 to determine that the vehicle route has changed (or there is a possibility that the vehicle route has changed) when the traffic information from a road traffic information communication system etc. is information to the effect that there are road works, there has been a traffic accident, or there is a traffic jam etc. at a certain location. It is preferable for the image processing unit 103 to move the cut-out image data 202 to be in a direction indicating information to the effect that there are road works, there has been a traffic accident, or there is a traffic jam etc.

For example, it is also possible for the control unit 107 to determine that the vehicle route has changed (or there is a possibility that the vehicle route has changed) when weather information from a road traffic information communication system etc. is information to the effect that there is rain, snow, or fog etc. in the region being traveled and that visibility is poor.

For example, it is also possible for the control unit 107 to determine that the vehicle route has changed (or that there is the possibility that the vehicle route will change) when road information from a road traffic information communication system etc. such as a number of vehicle lanes for the road the vehicle is traveling on (two lanes, three lanes etc.) or a position where a number of vehicle lanes merge is information to the effect that the number of lanes being traveled on is increasing or decreasing or that lanes are merging or diverging.

The receiving unit 105 can also receive speed data, acceleration data, rotational speed data, or brake signals etc. for the vehicle inputted from a speedometer, accelerometer, tachometer for an engine etc., or breaking device (brakes) the vehicle is equipped with as the information 151 indicating the vehicle driving conditions. The control unit 107 can also determine whether or not there is a change in the vehicle route based on the speed data, acceleration data, rotational speed data, or a brake signal received by the receiving unit 105. It is also possible to adopt a configuration where the driving assistance processing is started when the receiving unit 105 receives these control signals.

The present invention is by no means limited to the above embodiments and various modifications and applications are possible. It is also possible for each of the configurational elements of the other embodiments to be freely combined.

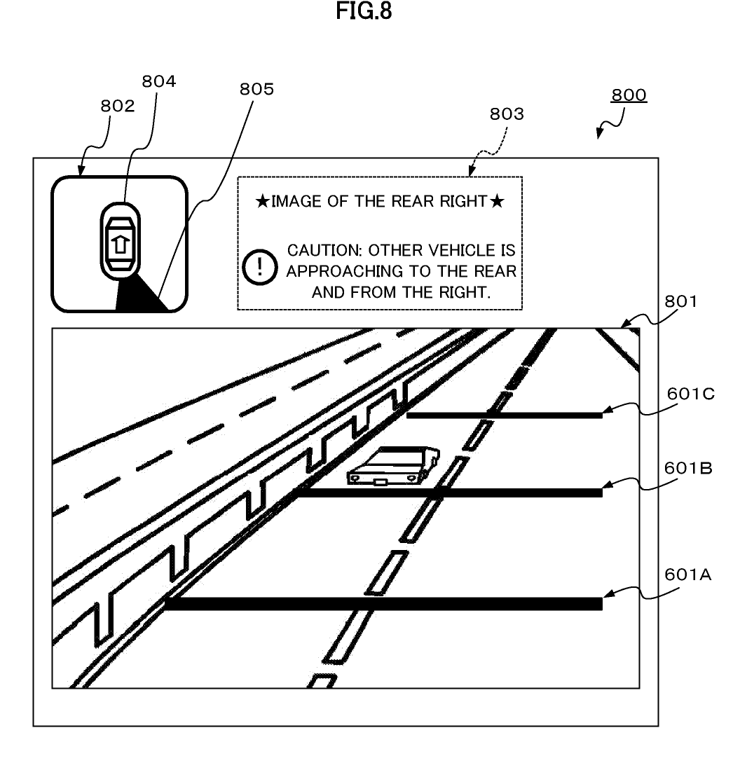

For example, FIG. 8 is an example configuration for a screen 800 projected on the monitor 123. An information displaying region 801 that displays image data synthesized from the cut-out image data 202 and the risk guidance lines 601 (or the risk guidance regions 701) that is the driving assistance data, a field of view display region 802 that shows a field of view range 805 corresponding to the cut-out region 401, and a message display region 803 are provided on the monitor 123. It is therefore possible for the user not to lose sight of what the direction of the image is that being projected on the monitor 123 by displaying the field of view display region 802 that shows at what angle the image projected on the monitor 123 is taken from the vehicle 804. This drawing is provided merely as an example and the configuration of the screen 800 can be freely changed.

In the embodiment described above, the camera 121 is fitted in the vicinity of the number plate or in the vicinity of the rear windscreen to the rear of the vehicle and the installation location is by no means limited in this respect. For example, it is also possible to install the camera 121 in the vicinity of a side mirror so as to photograph to the rear of the vehicle. In this event, it is preferable to fit the camera 121 in the vicinity of the side mirror on the opposite side to the side where the driver is driving. This makes it easier to take pictures in a direction where it is easy for blind spots for the driver to occur.

### Fourth Embodiment

A situation where the vehicle is traveling forwards is assumed in the above explanation but the driving assistance processing can also be carried out when the vehicle is reversing. It is also possible to adopt a configuration where driving assistance data is generated when the vehicle route changes and an obstacle (wall, person, fixed object, other vehicle etc.) is within a fixed distance. The following is an explanation of a fourth embodiment where driving assistance processing is carried out when the vehicle is reversing, and where driving assistance data is generated when the route changes and an obstacle is within a fixed distance.

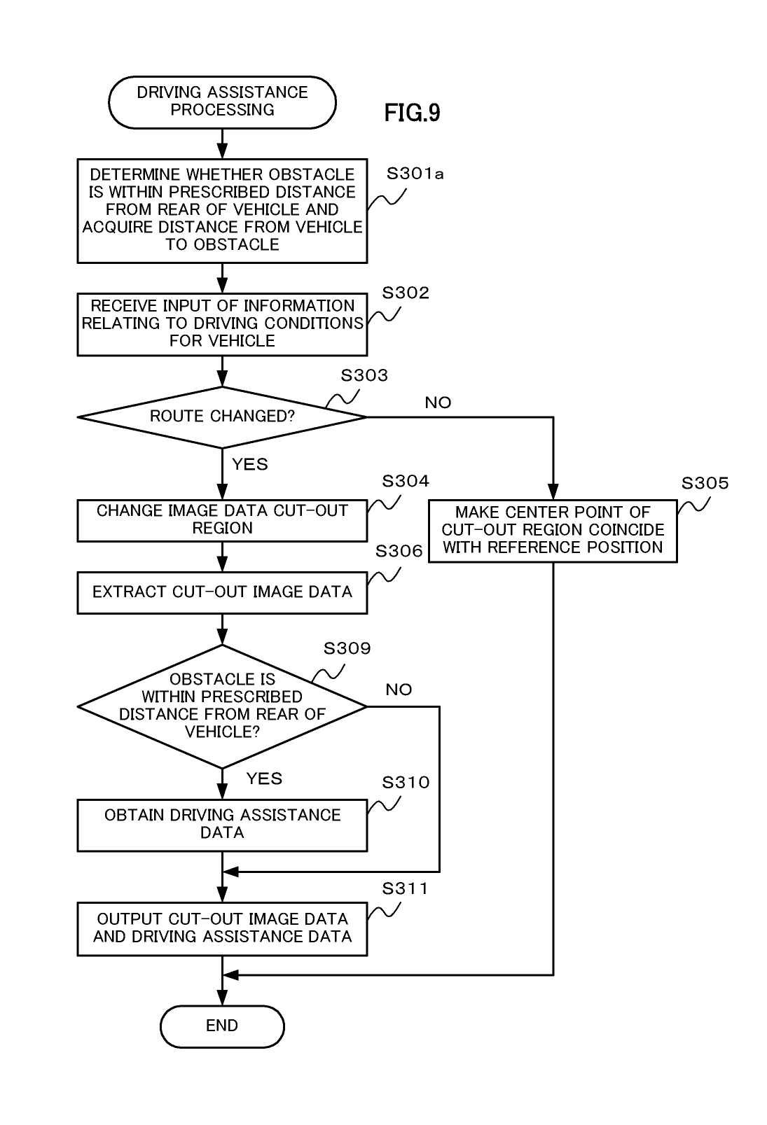

A flowchart of driving assistance processing of the fourth embodiment of the present invention is shown in FIG. 9. The driving assistance processing of the fourth embodiment is the same as the driving assistance processing of the first embodiment shown in FIG. 3 with the exception that a step S301a is executed in place of the step S301 and steps S309 to S311 are executed in place of the steps S307 and S308.

The driving assistance processing of the fourth embodiment is executed while the driver puts the gears into reverse. First, when the processing commences, the driving assistance device 100 first analyzes an image for the photographed image data 201 taken by the camera 121 and determines whether or not an obstacle is within a prescribed distance from the rear of the vehicle. When an obstacle exists, the driving assistance device 100 acquires the distance from the vehicle to the obstacle using the measuring unit 102 (step S301a).

After the driving assistance device 100 acquires the information 151 indicating the vehicle driving conditions (step S302), when the route is changed (step S303: Yes), the driving assistance device 100 moves a region cut-out from the image data from the reference position HP (step S304) and extracts the image data (step S305). The driving assistance device 100 then determines whether or not the distance from the vehicle to the obstacle acquired in step S301a is within the prescribed distance (step S309).

When the distance from the vehicle to the obstacle is within the prescribed distance (step S309; Yes), the driving assistance device 100 obtains the driving assistance data (step S310). For example, the type of the obstacle and the guideline bars (601, 701) etc. can be obtained as the driving assistance data using the same processing as in step S306.

When the distance from the vehicle to the obstacle is not within the prescribed distance (step S309; No), or after step S310, the driving assistance device 100 outputs the driving assistance data and the cut-out image data 202 (step S311). After step S305 or step S311, the driving assistance device 100 ends the driving assistance processing.

According to the driving assistance device of this embodiment, it is possible to provide driving assistance in a manner that is easy for the driver to understand at a low cost even when the vehicle is reversing. Driving assistance data can also be displayed when the route changes and obstacles such as other vehicles are nearby. It is therefore possible to invite the driver to be more cautious with regards to nearby obstacles than when driving assistance data is displayed regardless of the presence or absence of a change in route or regardless of the distance to an obstacle.

In the fourth embodiment described above, when the vehicle changes route (step S303; Yes), the cut-out region 401 is moved from the reference position HP (step S305). However, it is also possible to adopt a configuration where the cut-out region 401 is moved (step S305) when the distance between the vehicle and the obstacle is within the prescribed distance regardless of the presence or absence of a change in route (step S309; Yes).

In the embodiment described above, the cut-out region 401 is moved when the image processing unit 103 determines that the vehicle route has changed. However, it is also possible to move the cut-out region 401 as a result of the user operating the operation panel 125 connected to the receiving unit 105. For example, it is also possible for the receiving unit 105 to receive instructions to change the display angle for projection on the monitor 123 from the user regardless of changes of the vehicle route, with the image processing unit 103 then changing the cut-out region 401 to the instructed direction.

In the above embodiments, the camera 121 always photographs images to the rear but the timing of the photographing can be changed arbitrarily. For example, it is also possible for the camera 121 to start photographing when the vehicle route is determined to have changed in step S303.

In the above embodiments, the measuring unit 102 measures the relative speed of the other vehicle 213 with respect to the vehicle but it is also possible to measure the absolute speed of the other vehicle 213.

A program for causing all or part of the device to operate as the driving assistance device 100 can be stored and distributed on a computer-readable recording medium such as a memory card, a CD-ROM, a DVD-ROM, or an MO (Magneto-Optical disk) etc., and this can be installed on a separate computer so as to cause the computer to operate as the upper prescribed means or execute the steps described above.

It is also possible for the program to be stored on a disk device that is on a server device on the Internet so that, for example, a program can be downloaded etc. to a computer through superposition with a carrier wave.

This application is based on Japanese Patent Application No. 2006-305729 filed on Nov. 10, 2006, the entire disclosure of which is incorporated herein by reference in its entirety.

### INDUSTRIAL APPLICABILITY

As described above, according to the present invention, it is possible to provide a driving assistance device, a driving assistance method, and a program suited to providing driving assistance in a manner that is easy for a driver to understand and at low-cost.

1. A driving assistance device comprising:
a photographing unit that photographs an image to the rear of a vehicle;
a driving information acquiring unit that acquires driving information indicating driving conditions of the vehicle;
a route determining unit that determines the presence or absence of a change of a vehicle route and a direction of the change of the vehicle route based on the driving information acquired by the driving information acquiring unit;
an extracting unit that extracts a prescribed region from an image taken by the photographing unit based on the direction of the change of the vehicle route determined by the route determining unit when the vehicle route is determined to have changed by the route determining unit; and
a display unit that displays the image extracted by the extracting unit.

2. The driving assistance device according to claim 1, further comprising an assistance information generating unit that generates assistance information for assisting a driver based on the driving information acquired by the driving information acquiring unit and the image taken by the photographing unit,
wherein the display unit displays the image extracted by the extracting unit and the assistance information generated by the assistance information generating unit.

3. The driving assistance device according to claim 1, wherein the driving information acquiring unit acquires information indicating whether the vehicle is within a prescribed distance range from road markings and information indicating a direction the vehicle approaches the road markings in as driving information, and the route determining unit determines whether the vehicle is changing route by determining whether or not the vehicle is within a prescribed distance range from the road markings, and determines the direction of the change of the vehicle route based on the direction the vehicle approaches the road markings in.

4. The driving assistance device according to claim 2, further comprising: a storage unit that stores: vehicle type information indicating a type of a vehicle; and notification information for giving notification to a driver; in a correlated manner, and
a vehicle type determining unit that determines the type of other vehicle to the rear of the vehicle based on the image taken by the photographing unit,
wherein the assistance information generating unit reads out the notification information corresponding to the type of the other vehicle determined by the vehicle type determining unit and generates the assistance information including the notification information.

5. The driving assistance device according to claim 2, wherein the assistance information generating unit generates guidelines that provide a guide of distance from the vehicle and information indicating a position of arrangement of the guidelines on the image extracted by the extracting unit as the assistance information.

6. The driving assistance device according to claim 5, further comprising a measuring unit that measures an inter-vehicular distance or a relative speed between the vehicle and the other vehicle,
wherein the assistance information generating unit generates information indicating the number, shape, size, color, and a position of arrangement of the guidelines based on the inter-vehicular distance or the relative speed measured by the measuring unit as the assistance information.

7. The driving assistance device according to claim 1, wherein the driving information acquiring unit acquires direction indication information that indicates which direction is being indicated by a direction indicator of the vehicle as the driving information, and
the route determining unit determines the direction of the change of the vehicle route based on the direction indication information.

8. The driving assistance device according to claim 1, wherein the driving information includes at least one of information indicating vehicle speed, information indicating acceleration, information indicating engine speed, information indicating that brakes are being applied, road guidance information, position information, traffic information, weather information, and road information.

9. A driving assistance method comprising:
a photographing step of photographing an image to the rear of a vehicle;
a driving information acquiring step of acquiring driving information indicating driving conditions of the vehicle;
a route determining step of determining the presence or absence of a change of a vehicle route and determining a direction of the change of the vehicle route based on the driving information acquired in the driving information acquiring step;
an extracting step of extracting a prescribed region from the image taken in the photographing step based on the direction of the change of the vehicle route determined in the route determining step when it is determined that the vehicle route has changed in the route determining step; and
a displaying step of displaying the image extracted in the extracting step.

10. A program enabling a computer to function as:
a photographing unit that photographs an image to the rear of a vehicle;
a driving information acquiring unit that acquires driving information indicating driving conditions of the vehicle;
a route determining unit that determines the presence or absence of a change of a vehicle route and a direction of the change of the vehicle route based on the driving information acquired by the driving information acquiring unit;
an extracting unit that extracts a prescribed region from an image taken by the photographing unit based on the direction of the change of the vehicle route determined by the route determining unit when the vehicle route is determined to have changed by the route determining unit; and
a display unit that displays the image extracted by the extracting unit.
